(19) United States
(12) Patent Application Publication
(10) Pub. No.: US 2018/0287301 A1
(43) Pub. Date: Oct. 4, 2018

(54) CONNECTOR

(71) Applicant: FUJITSU COMPONENT LIMITED, Tokyo (JP)

(72) Inventors: Tetsugaku Tanaka, Tokyo (JP); Koichi Kiryu, Nagano (JP); Koki Sato, Tokyo (JP)

(21) Appl. No.: 15/860,053

(22) Filed: Jan. 2, 2018

(30) Foreign Application Priority Data
Mar. 31, 2017 (JP) 2017-069527

(51) Int. Cl. H01R 13/631; H01R 24/60

(52) U.S. Cl. CPC H01R 13/6315; H01R 2107/00; H01R 24/60

(57) ABSTRACT

A connector includes a fixed housing, a movable housing, and multiple contacts. Each of the fixed housing and the movable housing is formed of an insulator. The contacts are formed of a conductor. Each of the contacts has a first end fixed to the fixed housing and a second end fixed to the movable housing to displaceably connect the movable housing to the fixed housing. The movable housing includes a protrusion positioned between the contacts.

### CROSS-REFERENCE TO RELATED APPLICATION

The present application is based upon and claims priority to Japanese Patent Application No. 2017-069527, filed on Mar. 31, 2017, the entire contents of which are incorporated herein by reference.

### BACKGROUND OF THE INVENTION

### 1. Field of the Invention

The present invention relates to connectors.

### 2. Description of the Related Art

A floating connector, which is a socket connector to connect to a plug connector and includes a movable housing displaceable relative to a fixed housing to be fixed to a board, is known.

According to such a floating connector, the movable housing can move from a position where the movable housing is aligned with the fixed housing to eliminate a misalignment of the plug connector and the floating (socket) connector when the plug connector connects to the floating connector.

For related art, reference may be made to Japanese Laid-open Patent Publication Nos. 2007-103189, 2011-249076, and 2017-10611.

### SUMMARY OF THE INVENTION

According to an aspect of the present invention, a connector includes a fixed housing, a movable housing, and multiple contacts. Each of the fixed housing and the movable housing is formed of an insulator. The contacts are formed of a conductor. Each of the contacts has a first end fixed to the fixed housing and a second end fixed to the movable housing to displaceably connect the movable housing to the fixed housing. The movable housing includes a protrusion positioned between the contacts.

### BRIEF DESCRIPTION OF THE DRAWINGS

FIG. 1 is a side view of a plug connector and a socket connector;

FIG. 2 is a front view of the plug connector and the socket connector;

FIGS. 3A and 3B are structure diagrams of the socket connector;

FIG. 4 is a cross-sectional view of the socket connector;

FIG. 5 is an enlarged view of part of FIG. 4;

FIG. 6 is a perspective view of the socket connector;

FIG. 7 is an enlarged view of part of FIG. 6;

FIG. 8 is a diagram illustrating the socket connector;

FIG. 9 is a cross-sectional view of the socket connector;

FIG. 10 is a diagram illustrating a solder ball that has entered between socket contacts;

FIGS. 11A and 11B are structure diagrams of a socket connector according to an embodiment;

FIG. 12 is a cross-sectional view of the socket connector according to the embodiment;

FIG. 13 is an enlarged view of part of FIG. 12;

FIG. 14 is a perspective view of the socket connector according to the embodiment;

FIG. 15 is an enlarged view of part of FIG. 14;

FIG. 16 is a diagram illustrating the socket connector according to the embodiment; and

FIG. 17 is a cross-sectional view of the socket connector according to the embodiment.

### DESCRIPTION OF THE EMBODIMENTS

The floating connector includes socket contacts to contact plug contacts of the plug connector. The movable housing is displaceably connected to the fixed housing by the socket contacts. The fixed housing can be fixed to a printed board by soldering the terminals of the socket contacts connected to the fixed housing to electrode terminals of the printed board.

Such soldering is generally performed by reflow soldering, during which excessive solder paste may solidify to form a spherical mass of solder referred to as a solder ball. Once such a solder ball enters between and short-circuits socket contacts, the floating connector fails to function properly, thus impairing its reliability. In the following description, the term “reflow-mount” refers to mounting an object by such soldering.

Therefore, there is a demand for floating connectors whose reliability is not impaired by soldering.

According to an aspect of the present invention, it is possible to prevent the reliability of a floating connector from being degraded by soldering.

One or more embodiments of the present invention are described below with reference to the accompanying drawings. The same elements or members are referred to using the same reference numeral, and are not repetitively described.

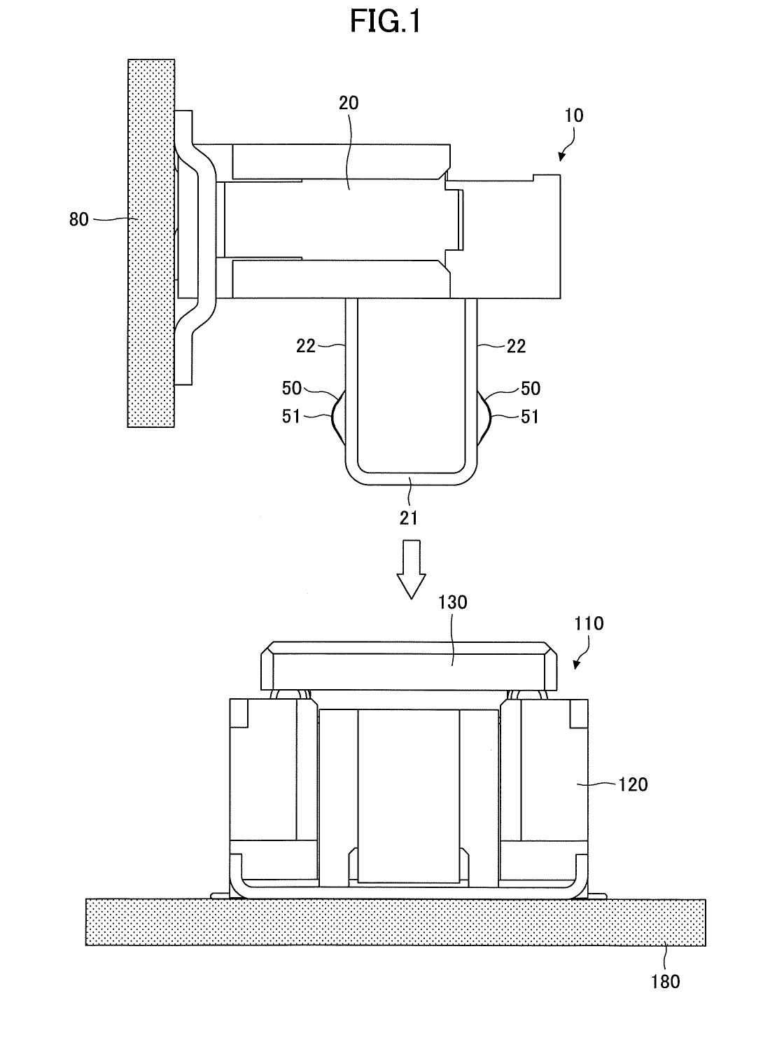

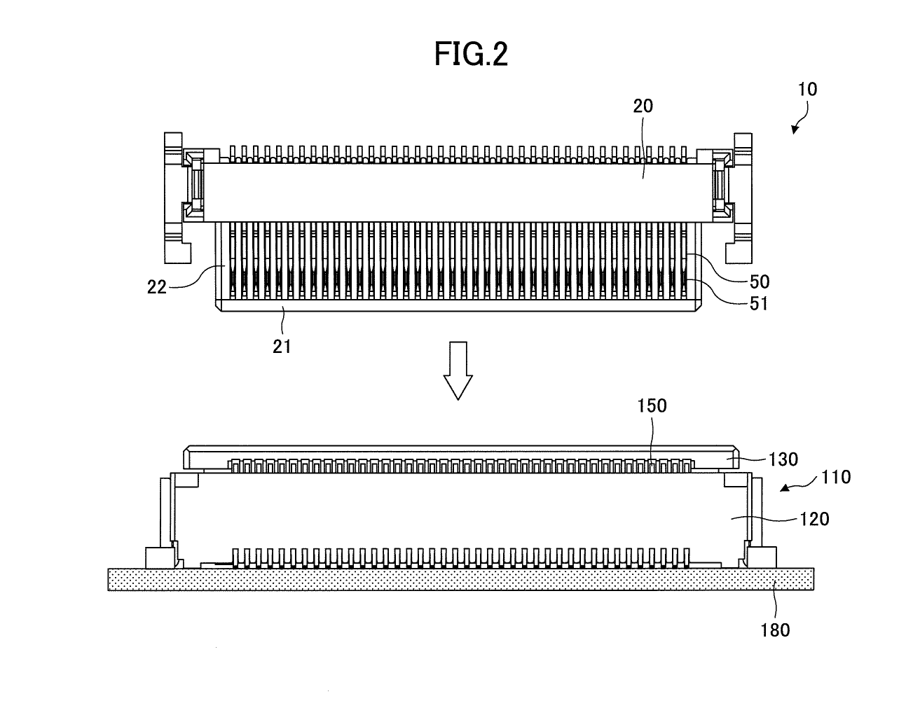

First, a floating connector is described. FIGS. 1 and 2 are a side view and a front view, respectively, of a plug connector 10 and a socket connector 110, which is a floating connector, before being fitted and connected.

The plug connector 10 includes a plug housing 20 and plug contacts 50 attached to the plug housing 20. The plug housing 20 is formed of, for example, an insulating resin material. The plug connector 10 is connected to a printed board 80. Specifically, each of the plug contacts 50, attached to the plug housing 20, has a terminal at one end soldered to one of electrode terminals of the printed board 80. The plug housing 20 includes a protruding insertion part 21 to be inserted into the socket connector 110. The plug contacts 50 are arranged on both sides 22 of the insertion part 21. Each plug contact 50 includes a contact part 51 to contact one of the below-described socket contacts near the other end. The plug contacts 50 are formed of a metal material and have springiness.

The socket connector 110 includes a fixed housing 120, a movable housing 130, and socket contacts 150. The fixed housing 120 and the movable housing 130 are formed of an insulator such as an insulating resin material. Each socket contact 150 has a terminal at one end soldered to one of electrode terminals of a printed board 180, so that the fixed housing 120 is fixed to the printed board 180.

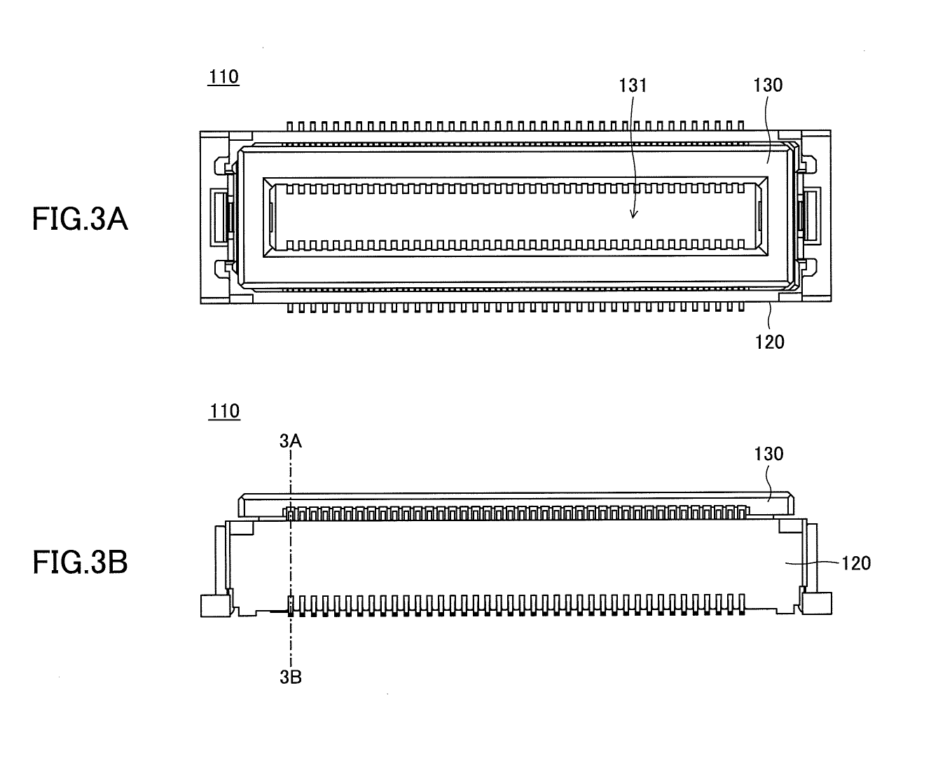

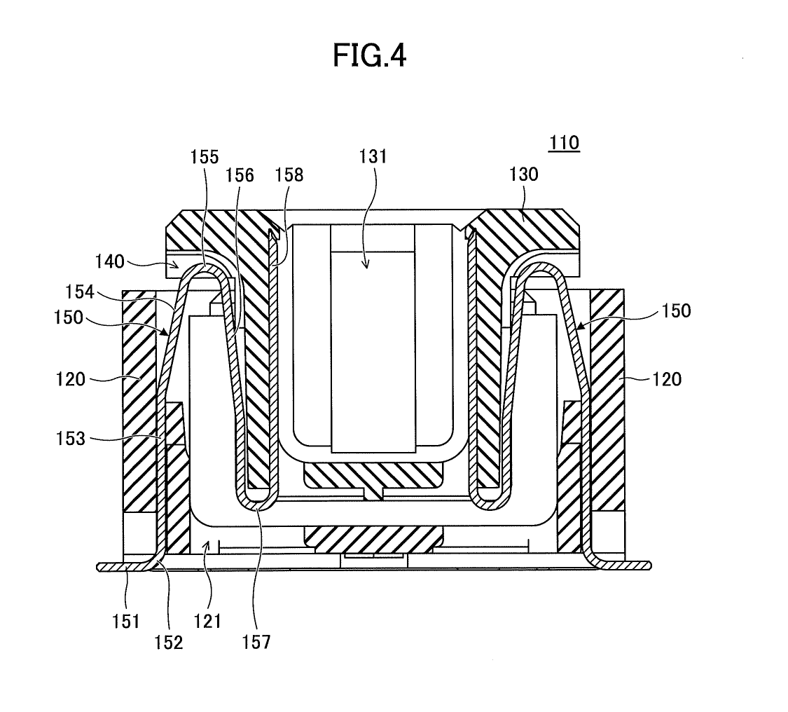

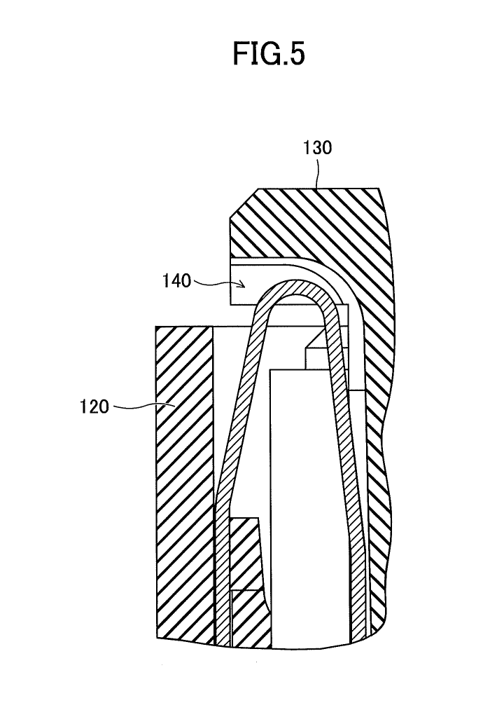

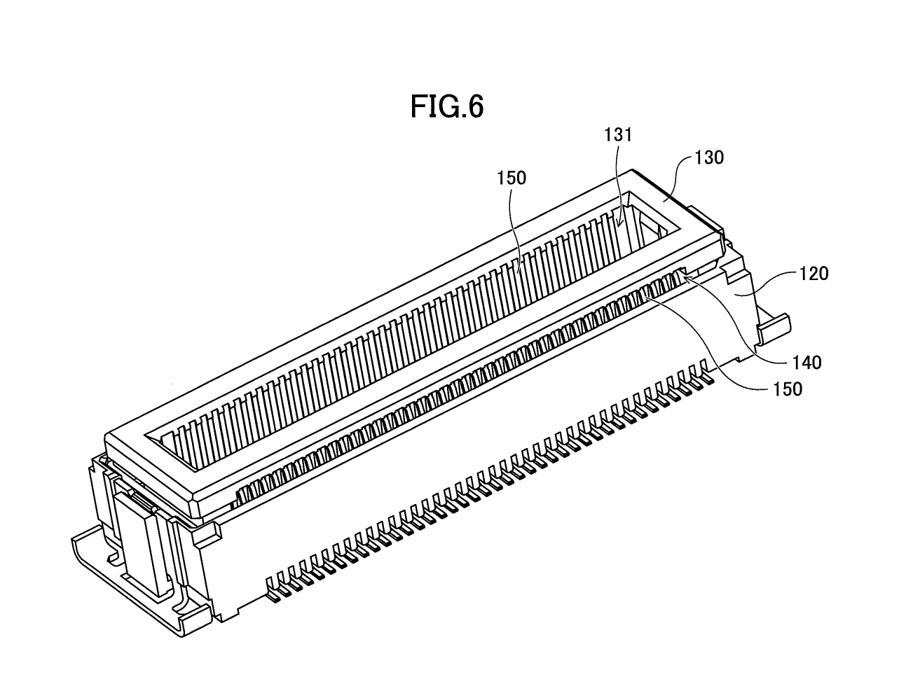

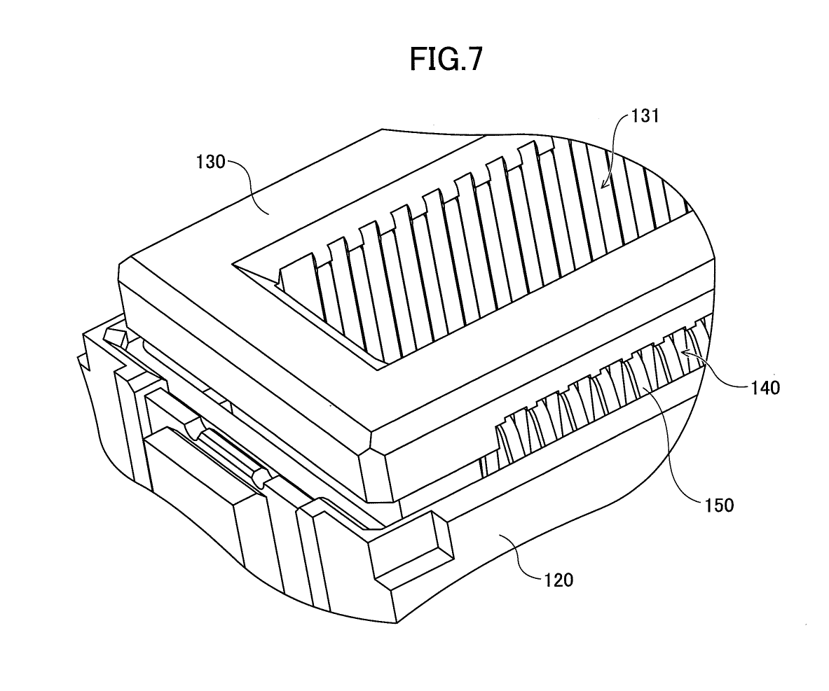

The socket connector 110 is described in more detail below with reference to FIGS. 3A and 3B and 4 through 7. FIGS. 3A and 3B are a plan view and a side view, respectively, of the socket connector 110. FIG. 4 is a cross-sectional view of the socket connector 110, taken along the one-dot chain line 3A-3B in FIG. 3B. FIG. 5 is an enlarged view of part of FIG. 4. FIG. 6 is a perspective view of the socket connector 110. FIG. 7 is an enlarged view of part of FIG. 6. In the following description, the socket contacts 150 are collectively referred to as “socket contact 150” where appropriate. Likewise, the plug contacts 50 are collectively referred to as “plug contact 50” where appropriate.

The fixed housing 120 has a rectangular frame shape including a rectangular opening 121 at the center in a plan view. The movable housing 130 has a substantially rectangular shape, and is accommodated in the opening 121 of the fixed housing 120. The movable housing 130 includes an opening 131 for inserting the insertion part 21 of the plug connector 10.

The socket contact 150 is formed of a metal material (a conductor), and includes a terminal 151, a first bent part 152, a fixed housing connection part 153, a displaceable part 154, a second bent part 155, an intermediate part 156, a third bent part 157, and a contact terminal 158 in order from one end to the other end. The socket contact 150 is bent substantially at 90° at the first bent part 152 between the terminal 151 and the fixed housing connection part 153. The socket contact 150 is gently bent where the displaceable part 154 extends from the fixed housing connection part 153. The socket contact 150 is bent substantially at 180° at the second bent part 155 between the displaceable part 154 and the intermediate part 156. The socket contact 150 is bent substantially at 180° at the third bent part 157 between the intermediate part 156 and the contact terminal 158. Each of the socket contacts 150, fixed to the fixed housing 120, has the terminal 151 soldered to one of electrode terminals of the printed board 180, so that the fixed housing 120 is fixed to the printed board 180.

The socket contacts 150 are approximately 0.1 mm in thickness and 0.2 mm in width, and are arranged with a pitch of 0.4 mm. The bend radius at the second bent part 155 is approximately 0.3 mm.

To connect the plug connector 10 and the socket connector 110, the insertion part 21 of the plug connector 10 is inserted into and fitted to the opening 131 of the movable housing 130 of the socket connector 110. As a result, the contact part 51 of the plug contact 50 contacts the contact terminal 158 of the socket contact 150 to electrically connect the plug connector 10 and the socket connector 110.

According to the socket connector 110, for example, the first bent part 152 and the fixed housing connection part 153 of the socket contact 150 are connected and fixed to the fixed housing 120, and the contact terminal 158 of the socket contact 150 is connected and fixed to the movable housing 130. Therefore, part of the socket contact 150 including the displaceable part 154 and the second bent part 155 that are not fixed between fixed parts is deformable. That is, the movable housing 130 is movably connected to the fixed housing 120 by the socket contacts 150. Specifically, the movable housing 130 is connected to the fixed housing 120 by the socket contacts 150 with the movable housing 130 movable (displaceable) laterally in the plane of paper of FIG. 4 and in the direction coming into and the direction coming out of the plane of paper of FIG. 4 relative to the fixed housing 120.

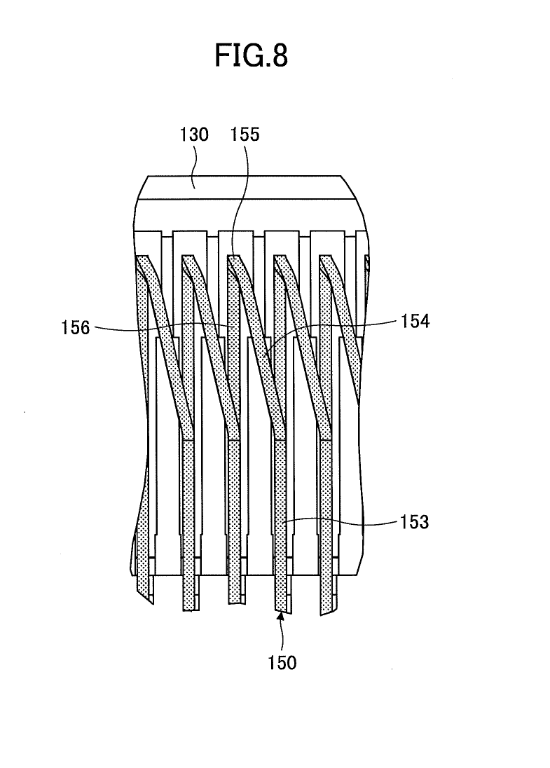

FIG. 8 illustrates the behavior of the socket contact 150 in the case where the movable housing 130 moves relative to the fixed housing 120. FIG. 9 illustrates part of a cross section of the movable housing 130 between adjacent socket contacts 150. In FIGS. 8 and 9, the socket contact 150 is indicated by a dot pattern for clarification.

Referring to FIGS. 4, 5 and 9, according to the socket connector 110, for example, the displaceable part 154 and the second bent part 155 of the socket contact 150, which are between a part connected to the fixed housing 120 and a part connected to the movable housing 130, are unfixed and freely movable. Accordingly, there is a space around the displaceable part 154 and the second bent part 155.

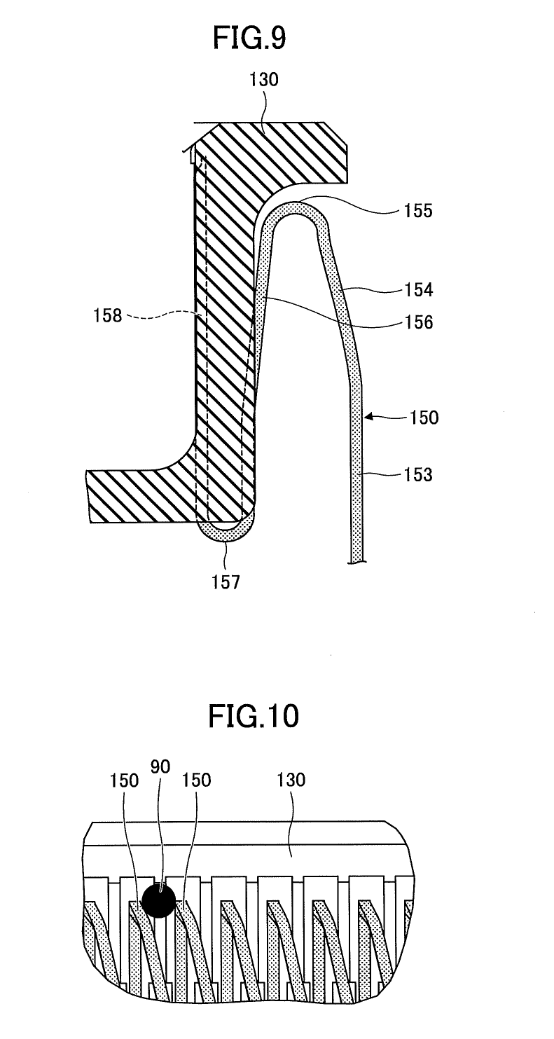

As described above, however, a solder ball may be produced when reflow-mounting the socket connector 110. FIG. 10 is a diagram illustrating a solder ball that has entered between socket contacts. If a solder ball 90 enters between adjacent socket contacts 150 as illustrated in FIG. 10, the adjacent socket contacts 150 may be short-circuited. That is, there is a space around the displaceable part 154 and the second bent part 155 at which the socket contact 150 deforms, and there is a gap 140 between the fixed housing 120 and the movable housing 130 as illustrated in FIGS. 4 through 7. Therefore, the solder ball 90 entering from outside through the gap 140 is likely to adhere between the second bent parts 155 of adjacent socket contacts 150 near the gap 140, which may short-circuit the adjacent socket contacts 150.

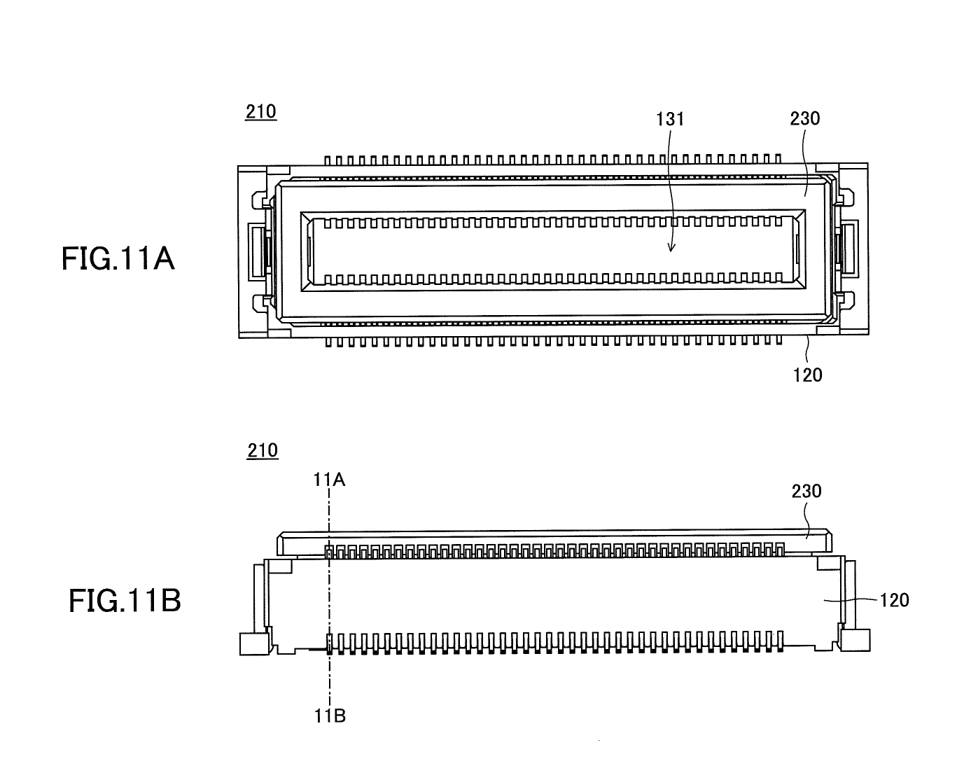

Next, a socket connector 210 according to an embodiment of the present invention is described with reference to FIGS. 11A and 11B and 12 through 15. The socket connector 210 is a floating connector, and is configured to connect to the plug connector 10.

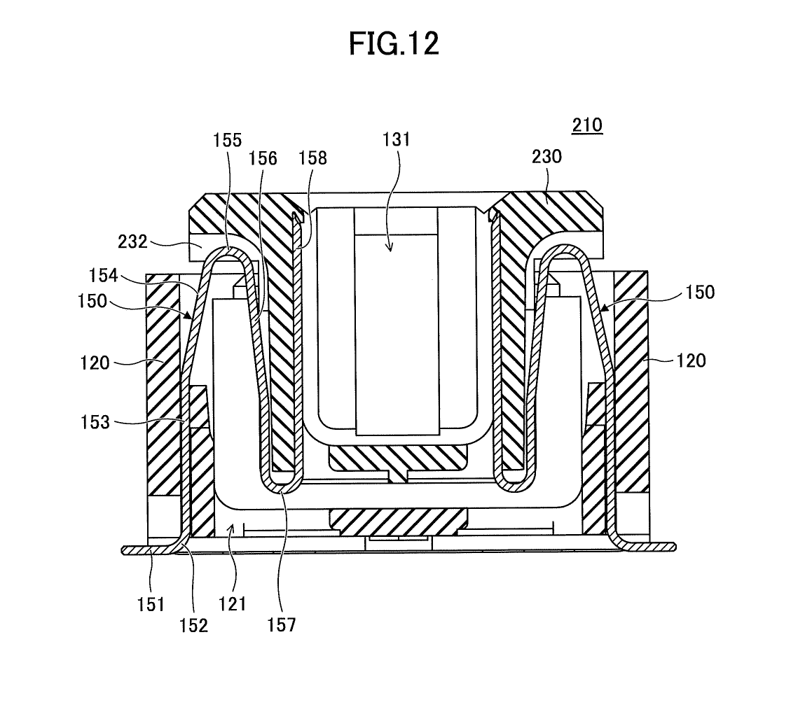

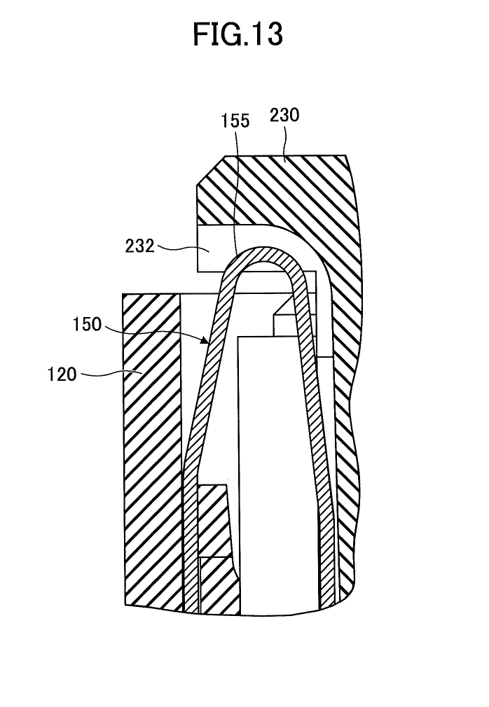

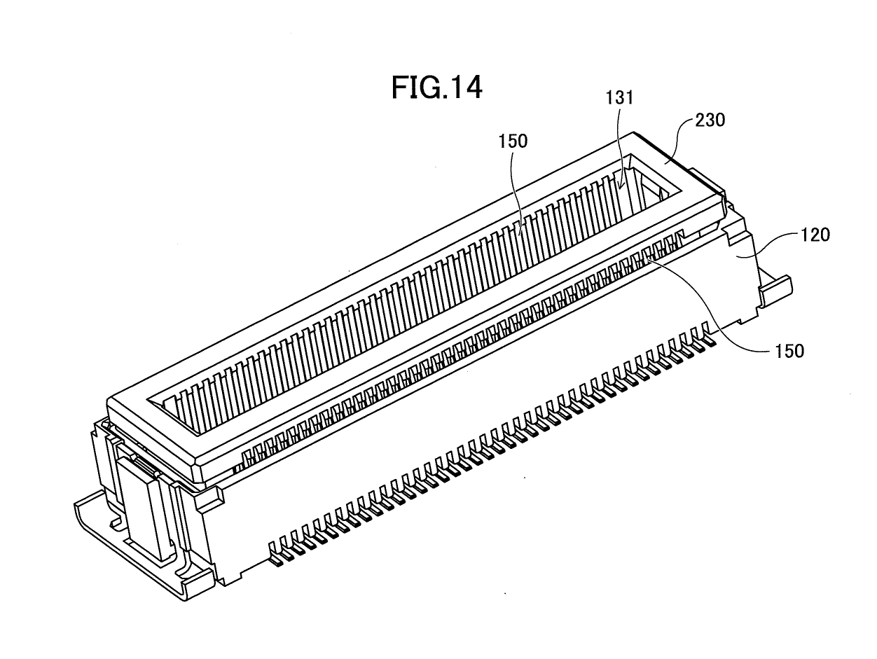

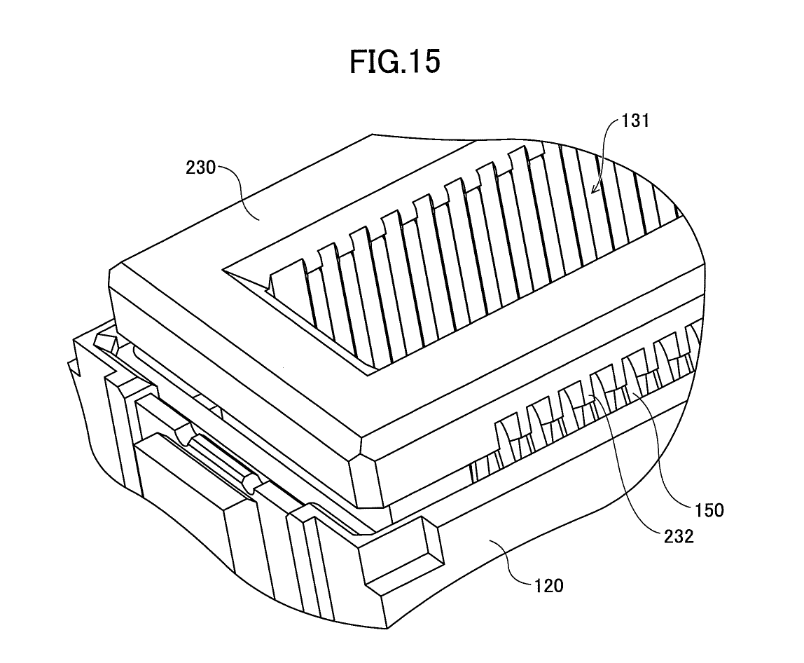

FIGS. 11A and 11B are a plan view and a side view, respectively, of the socket connector 210. FIG. 12 is a cross-sectional view of the socket connector 210, taken along the one-dot chain line 11A-11B in FIG. 11B. FIG. 13 is an enlarged view of part of FIG. 12. FIG. 14 is a perspective view of the socket connector 210. FIG. 15 is an enlarged view of part of FIG. 14.

The socket connector 210 includes the fixed housing 120, a movable housing 230, and the socket contacts 150. The fixed housing 120 is connected to a printed board. The movable housing 230 is formed of an insulator such as an insulating resin material, and is accommodated in the opening 121 of the fixed housing 120. The movable housing 230 includes the opening 131 for inserting the insertion part 21 of the plug connector 10.

According to the socket connector 210, the first bent part 152 and the fixed housing connection part 153 of the socket contact 150 are connected and fixed to the fixed housing 120, and the contact terminal 158 of the socket contact 150 is connected and fixed to the movable housing 230. Therefore, part of the socket contact 150 including the displaceable part 154 and the second bent part 155 that are not fixed between fixed parts is deformable. Accordingly, the movable housing 230 is movably connected to the fixed housing 120 by the socket contacts 150. Specifically, the movable housing 230 is connected to the fixed housing 120 by the socket contacts 150 with the movable housing 230 movable (displaceable) laterally in the plane of paper of FIG. 12 and in the direction coming into and the direction coming out of the plane of paper of FIG. 12 relative to the fixed housing 120.

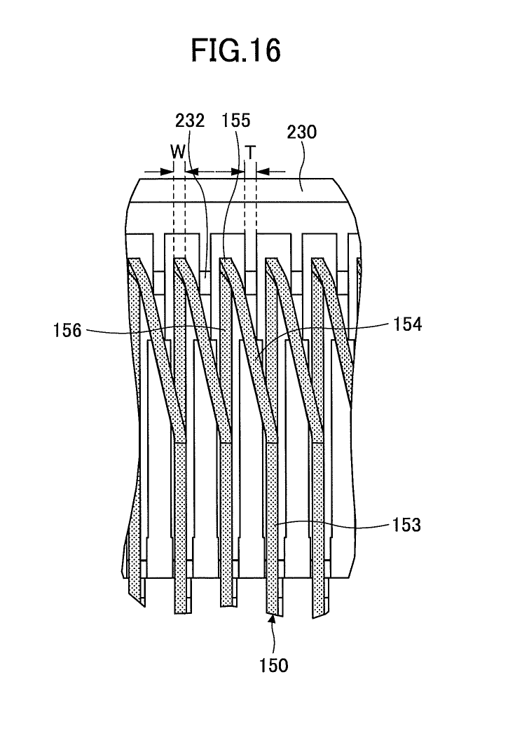

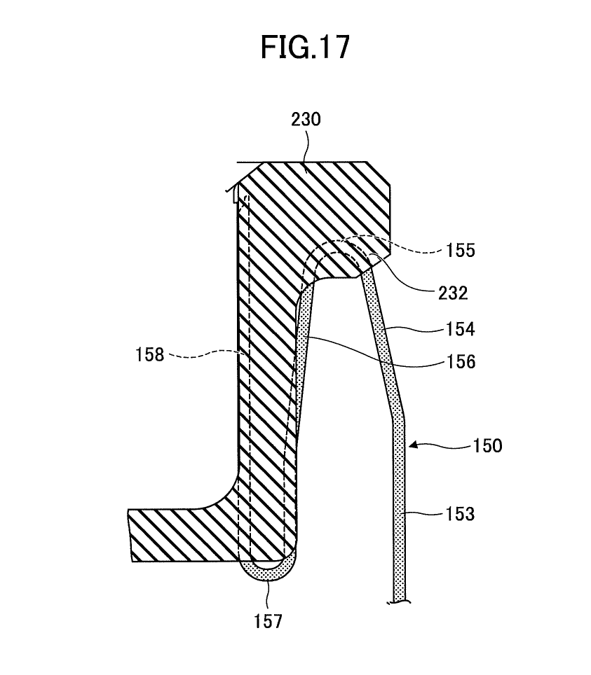

FIG. 16 illustrates the behavior of the socket contact 150 in the case where the movable housing 230 moves relative to the fixed housing 120. FIG. 17 illustrates part of a cross section of the movable housing 230 between adjacent socket contacts 150. In FIGS. 16 and 17, the socket contact 150 is indicated by a dot pattern for clarification.

Referring to FIG. 16, the movable housing 230 includes protrusions 232 arranged like comb teeth one between each adjacent two of the socket contacts 150. That is, the protrusions 232 alternate with the socket contacts 150 in a direction in which the socket contacts 150 are arranged. By thus providing the protrusions 232 one between each adjacent two of the socket contacts 150, it is possible to prevent a solder ball from entering between the second bent parts 155 of adjacent socket contacts 150. As a result, even when the socket connector 210 is reflow-mounted, it is possible to prevent the socket connector 210 from becoming less reliable. Each protrusion 232 enters between the second bent parts 155 of adjacent socket contacts 150 to protrude outward (in a direction toward the fixed housing 120) from the movable housing 230.

According to this embodiment, when the movable housing 230 is stationary relative to the fixed housing 120, the protrusions 232 of the movable housing 230 are out of contact with the socket contacts 150 in order not to hinder the movement of the movable housing 230. Referring to FIG. 16, the protrusions 232 have a thickness T of 0.12 mm to 0.15 mm. The socket contacts 150 have a width W of 0.2 mm, and are arranged with a pitch of 0.4 mm. Accordingly, the interval between each adjacent two of the socket contacts 150 is 0.2 mm.

According to the socket connector 210, the comb teeth-like protrusions 232 of the movable housing 230 are formed so that each protrusion 232 is positioned between the second bent parts 155 of adjacent socket contacts 150.

All examples and conditional language provided herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority or inferiority of the invention. Although one or more embodiments of the present invention have been described in detail, it should be understood that the various changes, substitutions, and alterations could be made hereto without departing from the spirit and scope of the invention.

What is claimed is:

1. A connector, comprising:
a fixed housing formed of an insulator;
a movable housing formed of an insulator; and
a plurality of contacts formed of a conductor, the plurality of contacts each having a first end fixed to the fixed housing and a second end fixed to the movable housing to displaceably connect the movable housing to the fixed housing,
wherein the movable housing includes a protrusion positioned between the plurality of contacts.

2. The connector as claimed in claim 1, wherein
each of the plurality of contacts includes a terminal at the first end, the terminal being configured to be soldered to a terminal of a board, and
the protrusion is out of contact with the plurality of contacts in an absence of a displacement of the movable housing relative to the fixed housing.

3. The connector as claimed in claim 1, wherein
each of the plurality of contacts includes a first part fixed to the fixed housing, a second part fixed to the movable housing, and a displaceable part between the first part and the second part, and
the protrusion is positioned between the displaceable parts of the plurality of contacts in a direction in which the plurality of contacts are arranged.

4. The connector as claimed in claim 3, wherein
the displaceable part of each of the plurality of contacts includes a bent part, and
the protrusion is positioned between the bent parts of the plurality of contacts. 20

5. The connector as claimed in claim 1, wherein
the movable housing includes a plurality of protrusions including the protrusion, and
the plurality of protrusions alternate with the plurality of contacts in a direction in which the plurality of contacts are arranged.
